(19) United States
(12) Patent Application Publication
(10) Pub. No.: US 2009/0009527 A1
(43) Pub. Date: Jan. 8, 2009

(54) LIQUID CRYSTAL DISPLAY DEVICE AND MOBILE TERMINAL DEVICE

(75) Inventors: Hideki Kuga, Kanagawa (JP); Tetsuji Suyama, Shizuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/908,642

(22) PCT Filed: Feb. 27, 2006
(86) PCT No.: PCT/JP2006/303625

§ 371 Date: Sep. 14, 2007

(30) Foreign Application Priority Data
Mar. 16, 2005 (JP) 2005-074962

(51) Int. Cl. G09G 5/02

(52) U.S. Cl. 345/589

(57) ABSTRACT

A liquid crystal display device capable of utilizing a backlight more effectively and more effectually and a mobile terminal device equipped with the liquid crystal display device are provided. A liquid crystal panel 6 of the liquid crystal display device contains a first display area on which a color display is given and a second display area on which a black and white display is given, and both areas are formed integrally to constitute the liquid crystal panel. The first display area contains color filters 63 and a black matrix 67, and the second display area does not contain the color filters 63 and the black matrix 67.

### TECHNICAL FIELD

The present invention relates to a liquid crystal display device and a mobile terminal device equipped with the liquid crystal display device.

### BACKGROUND ART

On account of the use of LED, etc. and the progress of constituent members of other backlights, a higher intensity of a backlight employed in a liquid crystal display device can be attained nowadays. In the meanwhile, higher definition and higher color purity of a color liquid crystal for a cellular phone are increasing more and more. It is apparent that a transmittance of the liquid crystal is lowered owing to this higher definition and this higher color purity, which is one of major causes leading to a situation that a high-intensity backlight is desired (see JP-A-11-167112, JP-A-11-202282, JP-A-2003-91269, etc.)

### DISCLOSURE OF THE INVENTION

### Problems that the Invention is to Solve

Because of the higher intensity of the backlight, the higher definition and the higher color purity can be achieved not to lower a surface intensity of the liquid crystal rather than the prior art. In case the liquid crystal display device is incorporated into the equipment such as a mobile terminal device, or the like, which is restricted by a space and a power supply capacity, it is desired that such backlight should be utilized more effectively.

The present invention provides a liquid crystal display device capable of utilising the above-mentioned backlight more effectively and more effectually, and a mobile terminal device equipped with the liquid crystal display device.

### Means for Solving the Problems

A liquid crystal display device of the present invention, includes a liquid crystal panel containing a first display area on which a color display is given and a second display area on which a black and white display is given, both areas being formed integrally; and a display controlling portion for controlling a display operation of the first display area and the second display area.

Since such configuration is employed, a fight of the backlight can be utilized effectively, a size reduction of the liquid crystal display device can be attained, and a battery can be utilized effectively. Also, the second display area can foe used in the display that is different from the first display area, and it is facilitated that a light of the backlight can be used as the effective lighting.

In the above configuration, the first display area contains color filters and a black matrix, and the second display area does not contain the color filters and the black matrix.

Since the color filters and the black matrix are deleted, a light of the backlight can be utilized effectively in the second display area.

Other constituent elements except the color filters and the black matrix are used commonly in the first display area and the second display area. According to this configuration, the first display area and the second display area can be formed simply.

Also, a liquid crystal display device of the present invention, includes a liquid crystal panel containing a first display area having first color filters and a second display area having second color filters whose color density is smaller than that in the first color filters, both areas being formed integrally; and a display controlling portion for controlling a display operation of the first display area and the second display area. This liquid crystal display device can achieve the same advantages as the above liquid crystal display device. Also, other constituent elements except the first color filters and the second color filters can be used commonly in the first display area and the second display area.

The liquid crystal panel can contain TFTs that are formed throughout the first display area and the second display area. In this case, the liquid crystal display device can be constructed such that the display controlling portion can control independently the TFTs only in a portion corresponding to the second display area.

According to the above configuration, the first display area and the second display area can be driven mutually independently, and thus an effective utilization of the battery, and the like can be attained.

The liquid crystal display device can be constructed such that a size of one pixel in the first display area is different from a size of one pixel in the second display area.

According to the above configuration, a degree of high definition of display in the second display area can be improved, a utilization factor of light can be improved, and the like.

Also, the second display area is formed in at least a part of peripheries of the liquid crystal panel.

According to the above configuration, the first display area and the second display area can be formed simply.

The above liquid crystal display device can be applied to a mobile terminal device. In this case, reference information acquired from an external equipment, an incoming call message, a charging message, or the like can be displayed in the second display area.

### ADVANTAGES OF THE INVENTION

A light of the backlight can be utilized effectively by employing the liquid crystal display device of the present invention. Therefore, a reduction in size of the liquid crystal display device can be achieved and also a battery can be utilized more effectively.

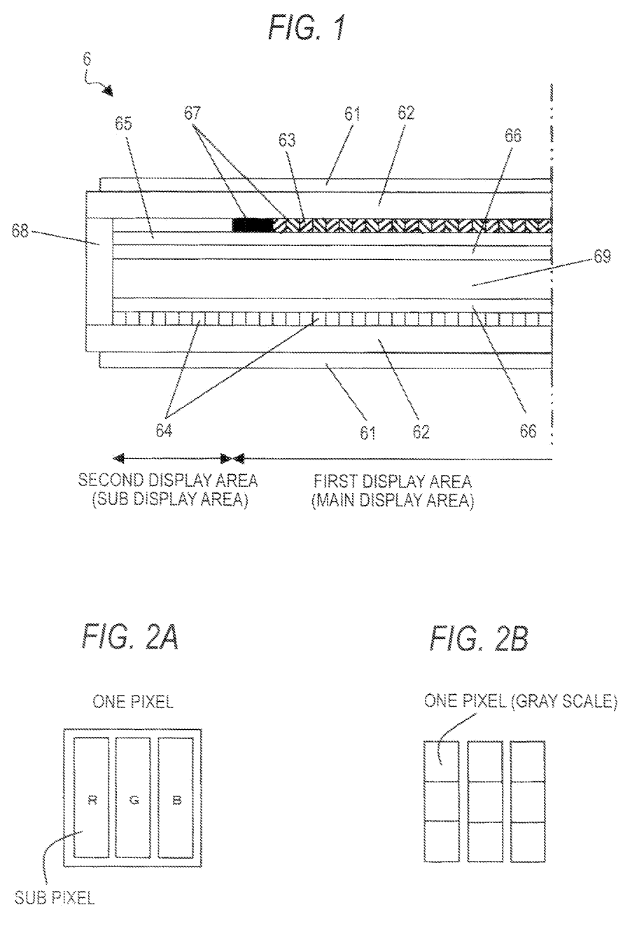

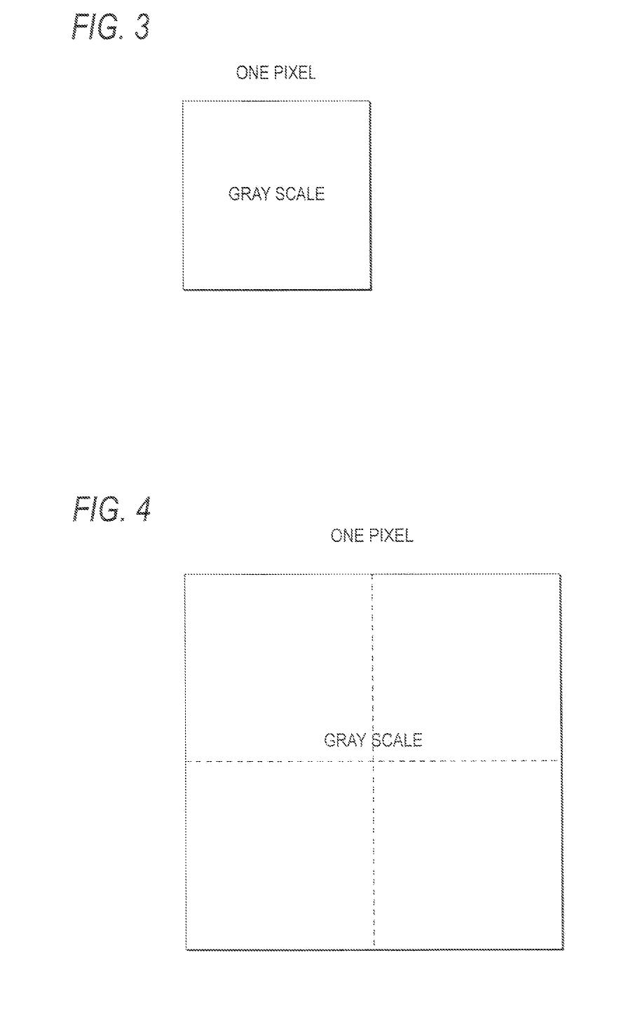

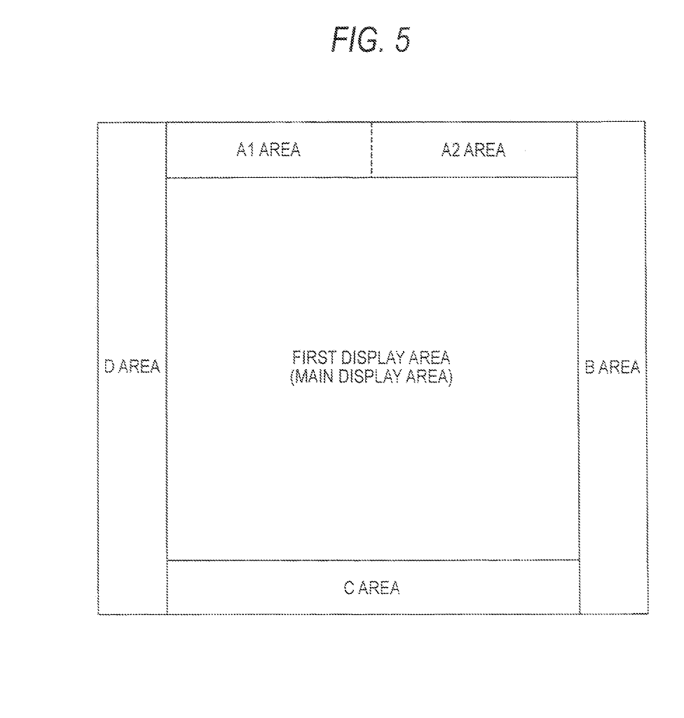

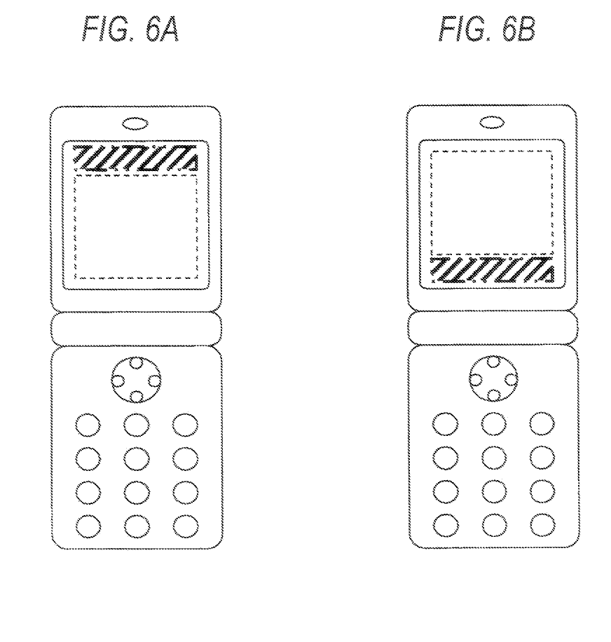

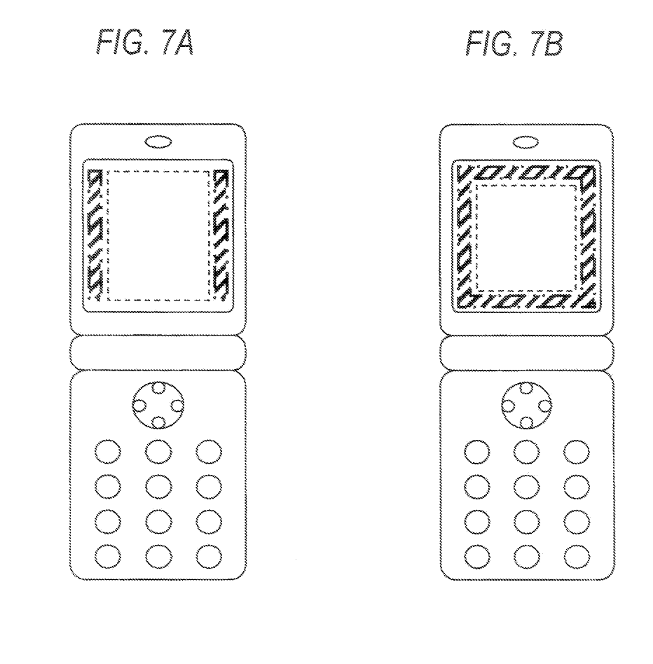

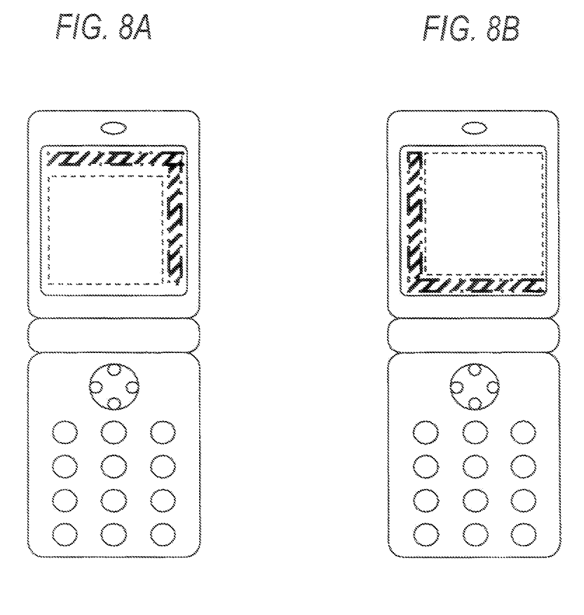

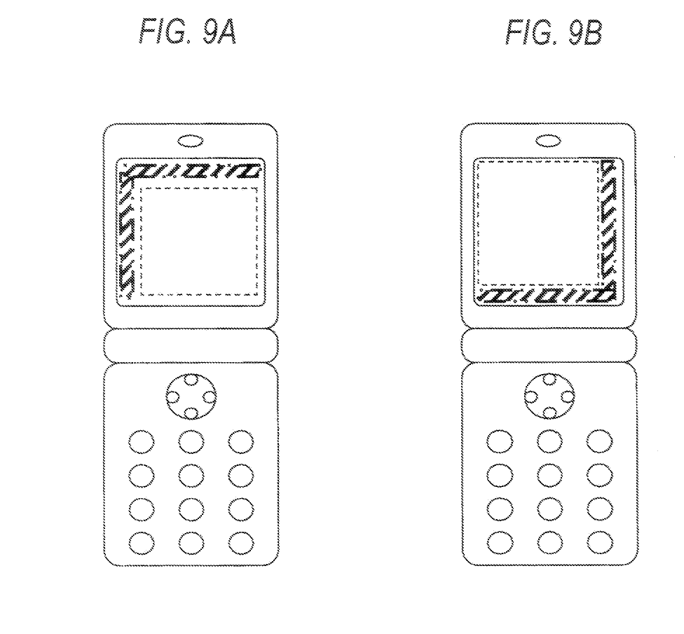

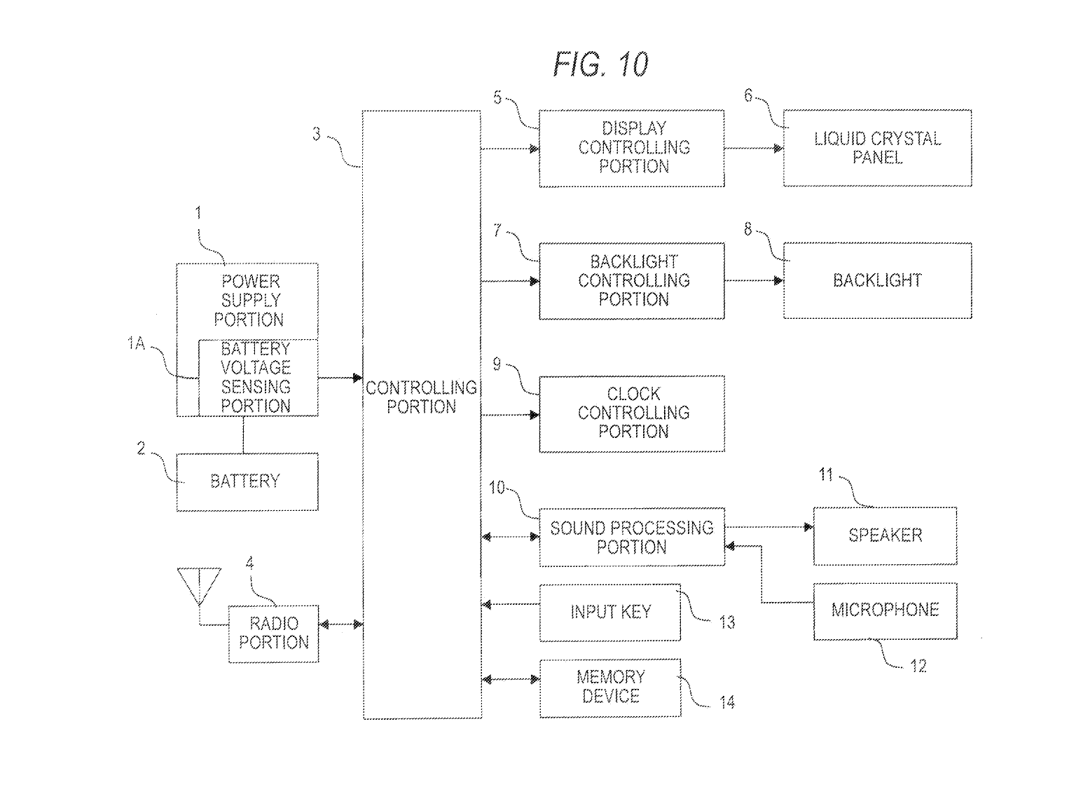

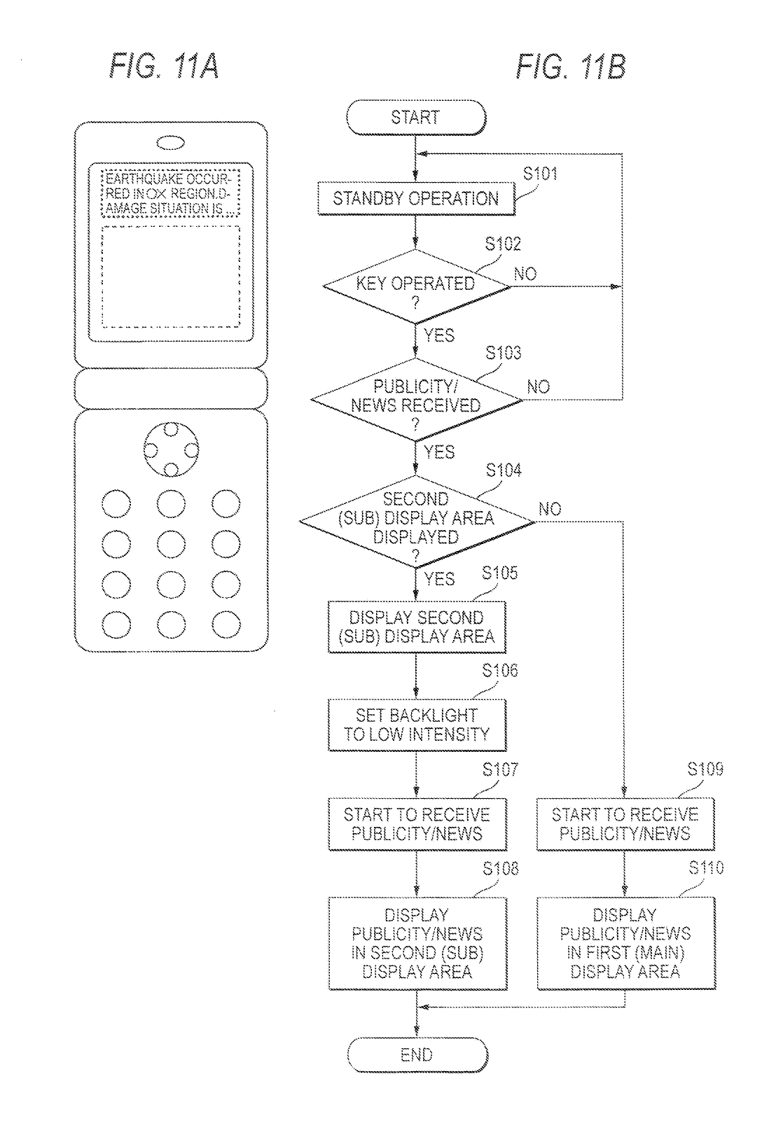

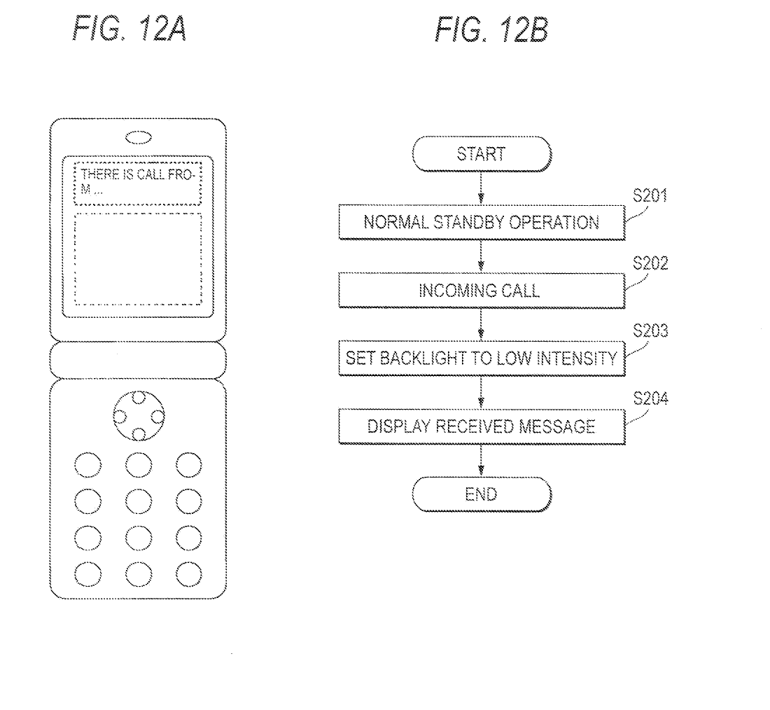

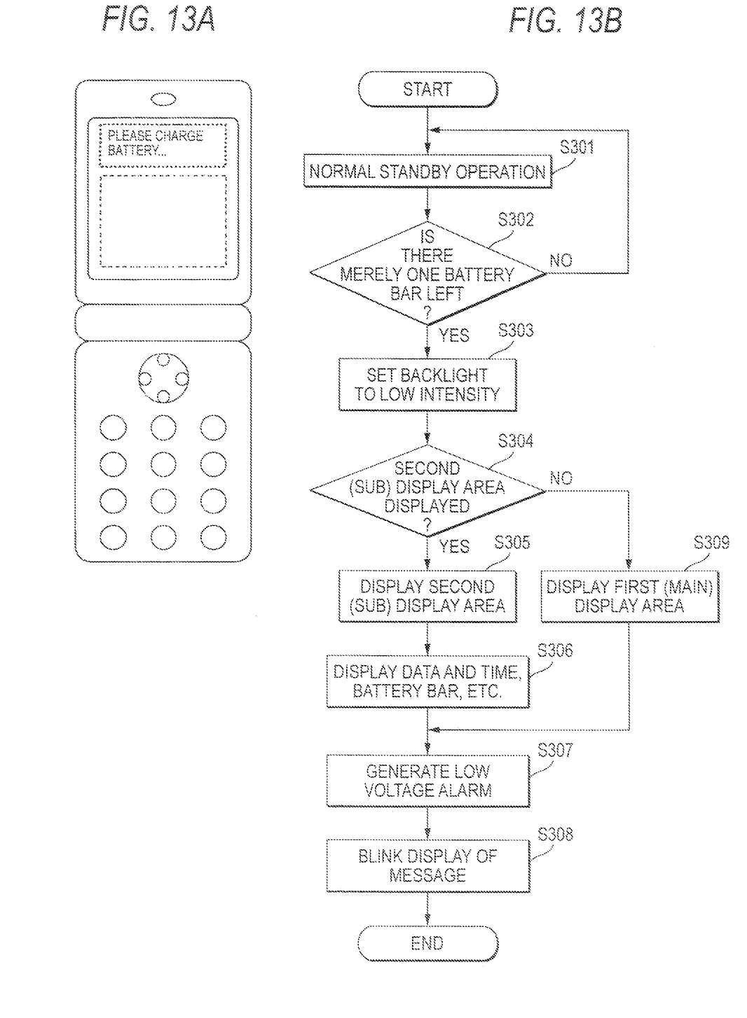

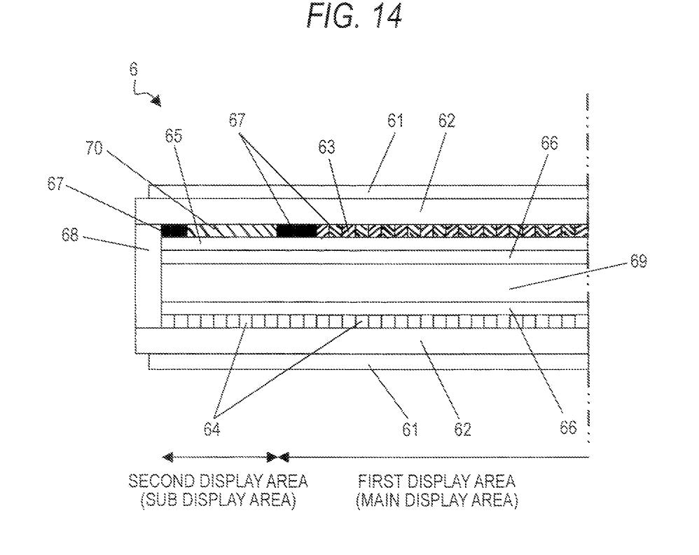

### BRIEF DESCRIPTION OF THE DRAWINGS

[FIG. 1] A partial sectional view of a liquid crystal panel.

[FIG. 2] A view comparing a size of one pixel, wherein (a) is an example of a color display in which one pixel is constructed by three RGB sub pixels, and (b) is an example in which one pixel is reduced to 1/9 in a black and white display area.

[FIG. 3] A view showing one pixel when one pixel in FIG. 2(a) is used in the black and white display area as it is.

[FIG. 4] A view showing one pixel when one pixel in FIG. 2(a) is enlarged to four times in the black and white display area.

[FIG. 5] A plan view of an example of a liquid crystal panel having a first display area and a second display area.

[FIG. 6] A view of an example of an arrangement and a shape of the second display area, wherein (a) is an example in which the second display area is formed at an upper end of the panel, and (b) is an example in which the second display area is formed at a lower end of the panel.

[FIG. 7] A view of an example of an arrangement and a shape of the second display area, wherein (a) is an example in which the second display area is formed at both right and left ends of the panel, and (b) is an example in which the second display area is formed on all peripheries of the panel.

[FIG. 8] A view of an example of an arrangement and a shape of the second display area, wherein (a) is an example in which the second display area is formed at an upper end and a right end of the panel, and (b) is an example in which the second display area is formed at a lower end and a left end of the panel.

[FIG. 9] A view of an example of an arrangement and a shape of the second display area, wherein (a) is an example in which the second display area is formed at an upper end and a left end of the panel and (b) is an example in which the second display area is formed at a lower end and a right end of the panel.

[FIG. 10] A block diagram of a mobile terminal device.

[FIG. 11] A view of a display example of publicity or news.

[FIG. 12] A view of a display example of an incoming message.

[FIG. 13] A view of a display example of a message advising to charge a battery.

[FIG. 14] A partial sectional view of another example of the liquid crystal panel.

### DESCRIPTION OF REFERENCE NUMERALS AND SIGNS

1 power supply portion
2 battery
3 controlling portion
4 radio portion
5 display controlling portion
6 liquid crystal panel
7 backlight controlling portion
8 backlight
9 clock controlling portion
10 sound processing portion
11 speaker
12 microphone
13 input key
14 memory device
61 polarizer
62 glass substrate
63 color filter
64 TFT
65 common electrode
66 alignment layer
67 black matrix
68 sealing material
69 liquid crystal

### BEST MODE FOR CARRYING OUT THE INVENTION

Embodiments of the present invention will foe explained with reference to the drawings hereinafter.

FIG. 1 shows a partial sectional view of a liquid crystal panel 6 that is applied to the liquid crystal display device of the present invention. Only the left half of the liquid crystal panel 6 is illustrated in this sectional view.

The liquid crystal panel 6 includes two sheets of polarizers 61 arranged on the outside of the panel two sheets of opposing glass substrates 62, a color filter 63, TFTs (Thin Film Transistors) 64, a common electrode 65, alignment layers 66, a black matrix (black mask) 67, a sealing material 68, and a liquid crystal 69 sealed by two glass substrates 62 and the sealing material 68.

The polarizer 61 transmits or absorbs a particular polarization component. The glass substrate 62 is a transparent substrate, and is formed of a nonalkaline glass that is commonly excellent in flatness. The color filter 63 is formed of a resin film in which dyes or pigments having three primary colors of red/green/blue (RGB) are mixed. The color filter produces various colors by a mixture of three primary colors (color display).

The TFT 64 constitutes a switching element for driving the liquid crystal, and is constructed by a transparent electrode, a metal wiring, and the like. The TFT 64 is arranged at intersection points between gate lines and data lines, which are aligned in a matrix fashion, respectively. When a pulse voltage (scanning signal) is applied to the gate line and a signal voltage is applied from the data fine, the TFT 64 acts as a switching element to control a voltage applied to the pixel. The TFTs 64 are formed throughout a first display area (main display area) and a second display area (sub display area). In contrast, the common electrode 65 is an electrode that is commonly formed of a transparent conductive thin film made of ITO (Indium Tin Oxide).

The alignment layer 66 is an organic thin film to align the liquid crystals, and is formed of a polyimide thin film, or the like. The black matrix (black mask) 67 is a light shielding film that is arranged between the pixels of the color filter. The sealing material 68 is an adhesive that joins respective peripheries of a glass substrate (TFT array substrate), on which the TFTs are formed, and a glass substrate (color filter array substrate), onto which the color filers are pasted, together. The liquid crystal 69 is sealed between the TFT array substrate and the color filter array substrate.

Normally, in the liquid crystal panel, a masking for preventing a light leakage of a backlight is applied to non-display areas except the display area on which the image is actually displayed. This masking is given by the black matrix that is arranged in the peripheral area of the panel.

In the liquid crystal panel 6 of the present embodiment, since an arrangement to transmit/block a light is provided in the non-display areas, so that a predetermined display or lighting such as character display, or the like can be realized. Also, in the non-display areas, a higher transmittance than that in the normal display area can be attained because the color filter is removed.

In FIG. 1, the foregoing configuration is illustrated concretely. The black matrix 67 is arranged adjacent to the end portion of the color filter 63, but the black matrix 67 is not extended to the end portion of the panel, i.e., the sealing member 68. In this portion, the color filter 63 is not provided, but a black and white display (gray scale display) can be provided because the TFTs 84 and the common electrode 65 as well as the polarizer 61 are provided. Therefore, as shown in FIG. 1, the liquid crystal panel 6 can be classified into a first display area (main display area) in which the color filters is arranged to give the color display and a second display area (sub display area) that gives a black and white display (gray scale display). Also, if the TFTs 64 in the first display area and the second display area are ON/OFF-controlled mutually independently, the display can be controlled independently in both areas. It is understood from FIG. 1 that remaining constituent elements except the color filter 63 and the black matrix 67 are used commonly in both areas. With this arrangement two areas can be formed simply in one panel.

In FIG. 1, the first display area and the second display area are formed physically integrally in a single liquid crystal panel.

Then, in light of a difference in the characteristic between both areas, a size of one pixel (one cell or one dot) in the first display area and a size of one pixel in the second display area can be differentiated. Examples will be explained with reference to FIG. 2 to FIG. 4 hereunder.

Normally, in the color filter, sub pixels corresponding to RGB respectively are formed and a group of three RGB sub pixels constitute one pixel to display the actual image (FIG. 2(a)). However, because the second display area is a black and white display area, an area corresponding to each sub pixel of RGB can be used as one pixel in the actual image display. Also, normally a size of vertically oriented sub pixels in the longitudinal direction can be reduced to ⅓ respectively, and also theoretically a degree of high definition can be increased nine times (⅓×⅓) rather than the RGB screen in the first display area. That is, the high-definition gray scale display can be achieved in the second display area (FIG. 2(b)).

In contrast, as described above, when the gray scale display is given at the same dot pitch as the RGB color display not to reduce an area corresponding to one pixel, an area corresponding to a group of three RGB sub pixels can be handled as one pixel (FIG. 3). In this case, a degree of high definition in the second display area is equal to that in the first display area, but higher contrast and higher intensity than the normal RGB color display can be realized in the second display area because the color filter is deleted from there. Therefore, the display having high visibility can be obtained.

In addition, in the second display area, since not only the color filter is removed but also an area corresponding to one pixel is enlarged rather than one pixel (a group of three RGB sub pixels) in the first display area, an aperture ratio can be improved, a transmittance can be improved, and attenuation of a light of the backlight transmitted from the rear portion can be reduced (in an example in FIG. 4, a size of one pixel is increased four times). In this case, the second display area can be utilized as an auxiliary light. Also, a black and white display can be controlled by providing the electrode to individual pixels. If the white display is given when the second display area is used as the auxiliary fight and the black display is given when the second display area is not used as the auxiliary light, auxiliary light control can be executed as occasion demands.

FIG. 5 is a plan view of an example of a liquid crystal panel having the first display area and the second display area. In an example in FIG. 5, the color filter is removed from peripheral areas on four sides of the normal display (the first display area), then the second display area is divided into an a area (an a1 area and an a2 area), a b area, a c area, and a d area as sub areas corresponding to respective sides, and then the electrode is provided independently to respective sub areas such that the lighting/non-lighting can be controlled independently every side. This configuration can be utilized as an incoming call informing function, or the like. Also, one side can be divided further into several small areas like the a1 area and the a2 area, and then the electrode can be provided to them. An illumination effect can be provided to the second display area by repeating sequentially the lighting in these areas, and thus the second display area can be utilized as a more effective informing function.

FIG. 6 to FIG. 9 show schematically various variations of a provided position and a shape of the second display area in the mobile terminal device by thick oblique lines, in theses examples, the second display area is formed at least in a part of the peripheries of the liquid crystal panel 6. In FIG. 6(a) the second display area is formed at an upper end of the panel, and in FIG. 6(b) the second display area is formed at a lower end of the panel. In FIG. 7(a) the second display area is formed at both right and left ends of the panel, and in FIG. 7 (b) the second display area is formed on all peripheries of the panel. In FIG. 8(a) the second display area is formed at an upper end and a right end of the panel, and in FIG. 8 (b) the second display area is formed at a lower end and a left end of the panel, in FIG. 9(a) the second display area is formed at an upper end and a left end of the panel, and in FIG. 9(b) the second display area is formed at a lower end and a right end of the panel.

FIG. 10 is a general block diagram of a mobile terminal device, particularly a cellular phone equipped with the liquid crystal display device of the present invention. The mobile terminal device includes a power supply portion 1, a battery 2, a controlling portion 3, a radio portion 4, a display controlling portion 5, a liquid crystal panel 6 (FIG. 1), a backlight controlling portion (step-up circuit portion) 7, a backlight 8, a clock controlling portion 9, a sound processing portion 10, a speaker 11, a microphone 12, an input key 13, and a memory device 14.

Then, the liquid crystal display device is constructed by the liquid crystal panel 6 and the display controlling portion 5. Also, a configuration constructed by the backlight controlling portion and the backlight 3 in addition to the liquid crystal panel 6 and the display controlling portion 5 can be defined as the liquid crystal display device.

The power supply portion 1 controls ON/OFF of the power supply of the mobile terminal device, and has a battery voltage sensing portion 1a to sense a remaining life of the battery 2. Normally the battery 2 consists of two or three battery bars (cells).

The controlling portion 3 executes the overall control of the mobile terminal device. The controlling portion 3 contains CPU that controls respective portions in compliance with a predetermined program, data, etc. and executes various operating processes, RAM that saves temporarily programs, data, etc., ROM that accumulates predetermined programs, etc., and the like.

The radio portion 4 transmits/receives a radio wave via an antenna, and is constructed by various radio circuits, a matching circuit, etc. The radio portion 4 not only accepts an incoming call from the other side terminal but also receives reference information described later.

The display controlling portion 5 receives the instruction from the controlling portion 3 to execute drive control of the liquid crystal panel 6, and constitutes a so-called liquid crystal driver (liquid crystal driving LSI). The liquid crystal panel 6 has a structure shown in FIG. 1, and displays a predetermined image. As described above, the display controlling portion 5 can ON/OFF-control the TFTs 64 in the first display area and the second display area in the liquid crystal panel 6 mutually independently and thus can execute the display control in both areas independently. Therefore, the display controlling portion 5 can control only the TFTs 64 of the liquid crystal panel 6 in the portion corresponding to the second display area independently (so-called partial drive).

The backlight controlling portion 7 is constructed by a set-up circuit that controls an intensity of the backlight, a lightening area, etc. The backlight 8 contains light guide plates and LEDs as a light source, and is normally arranged at the back of the liquid crystal panel 6. As the light source, the normal light bulbs can be uses instead of the LEDs. Also, reflectors, prism sheets, diffusers, etc. may be incorporated as the case may be.

The clock controlling portion 9 drives a clock incorporated into the mobile terminal device, controls a timer, etc. The sound processing portion 10 receives a received wave and the instruction issued based on predetermined functions from the controlling portion 3, converts it into sound information to be output from the speaker 11, and converts external sound information picked up via the microphone 12 into a predetermined signal that is output to the controlling portion 3. The input key 13 is constructed by various keys such as a cross key, a ten-key, and the like formed on an enclosure of the mobile terminal device. The memory device 14 is constructed by a nonvolatile memory, a miniature HDD, or the like, and stores data such as an address book, and the like.

According to the above configuration, publicity, news, etc., message of the incoming call message advising the user to charge a battery, message indicating that the battery is being charged, and the like can be displayed in the second display area whose current consumption is small. In other words, even when the backlight is set to a low intensity, the character recognition can be facilitated by using the second display area that has a high degree of definition or a high transmittance of light. Unlike the prior art, there is no need to employ other elements such as LED lamps provided separately, speakers, and the like, which consume a current, and therefore a current consumption can be reduced.

Also, the second display area can be used as the lighting when such area is turned ON at a maximum intensity. In addition, publicity, news, etc. can be displayed without change of a screen layout of the normal display area (first display area).

FIG. 11 shows an embodiment in which text information such as publicity, news, or the like corresponding to reference information (information that the user looks up to get any information) acquired from the outside via the radio portion is displayed, wherein (a) shows a display mode of reference information, and (b) is a flowchart showing displaying procedures. In the present embodiment, publicity, news, or the like is displayed in the form of character information in the second display area to which no color filter is provided. In the present embodiment, publicity, news, etc. can be displayed without change of a screen layout of the portion to which the color filter is provided (first display area). Also, if a scrolling function is utilized, enough messages can be dispatched in small numbers of dots. Also, even when the message such as disaster information, etc., which should be displayed all the time, is present, or the like, a low power consumption can be maintained because the second display area in which a light can be utilized effectively is employed. Operating procedures will be given as follows.

During a normal standby operation (step S101), if it is sensed that any key operation is applied via the input key 13 (step S102; Yes), it is decided whether or not reception of publicity/news (reference information) is set by this operation (step S103). If no key operation is sensed (step S102; No) or if the key operation does not set the reception of publicity/news (step S103; No), the mobile terminal device is set in a standby operation mode again.

If it is decided that the key operation sets the reception of publicity/news (step S103; Yes), it is decided whether or not the received information should foe displayed in the second display area (sub display area) (sub display area partial drive) (step S104). This decision is made based on information regarding a display method contained in the received information (which display mode should be selected).

If it is decided that publicity/news, or the like should be displayed in the second display area (step S104; Yes), the second display area is selected as the display area (step S105). Then, the backlight is set to a low intensify (step S106). Then, reception of the publicity/news via the radio portion 4 is started (step S107). Then, the received information is displayed in the second display area (step S108).

In contrast, if it is decided that publicity/news, or the like should not be displayed in the second display area (step 104; No), reception of the publicity/news is started directly (step S109). Then, the received information is displayed in the first display area (main display area) (step S110).

FIG. 12 shows an embodiment in which an incoming message is displayed, wherein (a) shows a display mode of an incoming message indicating that a call comes in, and (b) is a flowchart showing displaying procedures, in the present embodiment, unlike the normal cellular phone, not only the vibration but also the character display of the incoming message in the second display area informs the user of the incoming call. Operating procedures will be given as follows.

During the normal standby operation (step S201), if it is sensed that the incoming call arrives (step S202), the backlight is set to the low intensity (step S203). Then, the received message is displayed in the second display area (step S204).

FIG. 13 shows an embodiment in which a charging message such as a message advising to charge a battery, a message indicating that a batter is in charging, or the like is displayed, wherein (a) shows a display mode of a charging message, and (b) is a flowchart showing displaying procedures. In the present embodiment, when a battery voltage is lowered, such battery voltage is sensed to extend even a little a life of the battery. Then, the second display area is flashed to inform the user of this low voltage, and also a mode of the liquid crystal panel can be changed into a display mode using only the second display area (sub display area partial drive) (LVA; Low Voltage Alarm). In addition, an intensity of the backlight is lowered. Operating procedures, will be given as follows.

During the normal standby operation (step S301), it is decided via the battery voltage sensing portion 1a whether or not there is merely one battery bar of the battery 2 left (step S302). If it is decided that the remaining battery bar is only one (step S302; Yes), an intensity of the backlight is set to a low intensity (step S303). In contrast, if it is not decided that the remaining battery bar is only one (step S302; No), the mobile terminal device is set to a standby operation mode again.

After an intensity of the backlight is set to a low intensify, it is decided based on default whether or not the displayed in the first display area should be continued subsequently (step S304). If the setting in the default indicates that the display should be switched to the second display area (step S304; Yes), the display in the second display area is started (step S305). Then, data and time, battery bar, etc, are displayed in the second display area (step S308). Then, a low voltage alarm is generated (step S307). Then, the message advising a charging is displayed in the second display area (step S308).

In contrast, if the setting in the default does not indicate that the display should be switched to the second display area (step S304; No), the display in the first display area is continued (step S309). Then, a low voltage alarm is generated (step S307). Then, the message advising a charging is displayed in the second display area (step S303).

In respective modes in FIG. 11 to FIG. 13, a blinking drive for the second display area can be applied simultaneously. In this case, a blinking mode can be changed in respective sub areas in the second display area shown in FIG. 5.

Also, an auxiliary light can be obtained by employing the liquid crystal display device of the present invention. Such auxiliary light can be used as an auxiliary light in the illumination applied to the device itself (own illumination) or the illumination applied to the equipment except the device itself (illumination for an external equipment).

In the case of own illumination, this illumination is used as the illumination that is available for a talking over a television telephone in a dark place or a self-shooting by a camera, and thus there is no need to provide the illumination unit separately. Also, even when an intensity of the backlight is reduced to an undazzling extent in a dark place, an intensity can be ensured sufficiently as the auxiliary light because no color filter is provided.

In the case of illumination for an external equipment, an overall area of the first display area and the second display area is displayed by a white light and also the backlight is set to a high intensity, and thus this mobile terminal device can be used as the illumination in the dark, or the like. Only the second display area a light utilization efficiency of which is high can be lightened fully.

Also, date and time, time, antenna bar, battery bar, pict (pictorial symbol), etc., which seem to be considered as the required minimum, can be displayed in the second display area. In this case, the sufficient recognition can be attained even when the setting of the backlight is changed to the low intensify. When the display in the first display area is turned OFF, i.e., the display only in the second display area is turned ON, and the backlight is turned OFF (partial display), a further low consumption power can be realized.

FIG. 14 shows another example of the liquid crystal panel 6 used in the present invention, wherein another color filter 70 (second color filter) is provided in the portion of the second display area and a black matrix 67 is provided adjacent to the sealing member 68. Here, a density of RGB colors in this color filter 70 is set smaller than that of the color filter (first color filter) 63 in the first display area respectively. For example, the color filter 70 can be obtained by reducing a disperse concentration of pigments rather than the color filter 63.

Because the color filter 70 is present, the second display area gives not the black & while display but the color display. However, since a color density of the color filter 70 is small, a transmittance of a light from the backlight is large rather than a transmittance of the color filter 63. Therefore, an intensity of the backlight can be lowered in the display of the second display area and as a result a low consumption power can be attained. Namely, the liquid crystal in another example can be used by the same method as the liquid crystal in FIG. 1, and can achieve the same advantages. The color filter 63 and the color filter 70 can be constructed in the same film, or can be formed in separate films respectively.

The liquid crystal display device of the present invention can derive its advantage particularly when this device is incorporated into a small-sized equipment. But the equipment as the object of incorporation is not limited to the mobile terminal device, and this liquid crystal display device may be incorporated into other equipments.

With the above, various embodiments of the present invention are explained, but the present invention is not limited to the matters illustrated in the embodiments. The present invention is susceptible to various modifications and adaptations that are made by those skilled in the art based on the description of the specification and the well-known technologies and are contained in a scope in which protection is demanded.

This application is based upon Japanese Patent Application (Patent Application No. 2005-074982) filed Mar. 16, 2005; the contents of which are incorporated herein by reference.

### INDUSTRIAL APPLICABILITY

According to the present invention, the liquid crystal display device capable of utilizing effectively a light of the backlight and attaining easily a reduction in size can be provided.

1. A liquid crystal display device, comprising:
a liquid crystal panel which contains a first display area for performing a color display and a second display area for performing a black and white display, both of the first and second display areas being formed integrally; and
a display controlling portion which controls a display operation of the first display area and the second display area.

2. The liquid crystal display device according to claim 1, wherein the first display area contains a color filter and a black matrix, and
wherein the second display area does not contain the color filter and the black matrix.

3. The liquid crystal display device according to claim 1 or 2, wherein other constituent element except the color filter and the black matrix is used commonly in the first display area and the second display area.

4. A liquid crystal display device, comprising:
a liquid crystal panel which contains a first display area having a first color filter and a second display area having a second color filter whose color density is smaller than that in the first color filter, both of the first and second display areas being formed integrally; and
a display controlling portion which controls a display operation of the first display area and the second display area.

5. The liquid crystal display device according to claim 4, wherein other constituent element except the first color filter and the second color filter is used commonly in the first display area and the second display area.

6. The liquid crystal display device according to any one of claims 1 to 5, wherein the liquid crystal panel contains TFTs that are formed throughout the first display area and the second display area.

7. The liquid crystal display device according to claim 6, wherein the display controlling portion controls only a portion of the TFTs corresponding to the second display area independently.

8. The liquid crystal display device according to any one of claims 1 to 7, wherein a size of one pixel in the first display area is different from a size of one pixel in the second display area.

9. The liquid crystal display device according to any one of claims 1 to 8, wherein the second display area is formed in at least a part of peripheries of the liquid crystal panel.

10. A mobile terminal device comprising the liquid crystal display device set forth in any one of claims 1 to 9.

11. The mobile terminal device according to claim 10, further comprising:
a radio portion which acquires reference information from an external equipment,
wherein the acquired reference information is displayed in the second display area.

12. The mobile terminal device according to claim 10, further comprising:
a radio portion which receives an incoming call from other terminal,
wherein a message of the incoming call is displayed in the second display area when the device receives a call from the other terminal.

13. The mobile terminal device according to claim 10, further comprising:
a battery voltage sensing portion which senses a reduction in a battery voltage,
wherein a charging massage is displayed in the second display area when a battery voltage is lowered.
